(19) United States
(12) Patent Application Publication
(10) Pub. No.: US 2017/0090195 A1
(43) Pub. Date: Mar. 30, 2017

(54) SELECTIVE OBJECT FILTERING DEVICES, SYSTEMS AND METHODS

(71) Applicant: INTEL CORPORATION, Santa Clara, CA (US)

(72) Inventors: KAHYUN KIM, Hillsboro, OR (US); ZACHARY L. BRAND, Santa Clara, CA (US); ALEXANDER ESSAIAN, Santa Clara, CA (US)

(73) Assignee: INTEL CORPORATION, Santa Clara, CA (US)

(21) Appl. No.: 14/865,997

(22) Filed: Sep. 25, 2015

(51) Int. Cl. G02B 27/01; G02B 27/00

(52) U.S. Cl. CPC G02B 27/0172; G02B 27/0093; G02B 2027/0138; G02B 2027/014; G02B 2027/0141

(57) ABSTRACT

A selective display system may include a display controller circuit that receives image data that includes images of a scene that contains one or more objects. The selective display system autonomously identifies the objects contained in the scene. The selective display system compares the identified objects against an inventory to determine whether the identified object is represented in the inventory. The selective display system provides an output of the scene in which the identified objects represented in the inventory are presented in a first, unobscured, format and identified objects not represented in the inventory is presented in a second, obscured, format.

### TECHNICAL FIELD

The present disclosure relates to display devices.

### BACKGROUND

Many everyday tasks involve identifying objects meeting one or more defined selection criterion that included in a large group of objects, some of which may not meet the one or more defined selection criterion. For example, a consumer may be tasked with identifying objects such as consumer goods that meet one or more dietary requirements (e.g., gluten free items, Kosher items, Halal items) from a large assortment of objects on a store shelf. Such a task may involve the consumer pulling individual items from the store shelf and examining the item for ingredients (gluten-free) or preparation and/or various certifications (Kosher, Halal). Examining individual items in this manner is both time consuming and prone to error. In another example, an employee may be tasked with retrieving a specific class of objects located in a warehouse filled with similarly packaged objects. Such a task may involve the employee opening containers such as boxes to examine the contents prior to retrieving the objects. Again, examining individual items in this manner is both time consuming, inefficient, and prone to error.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic diagram of an illustrative selective display system, in accordance with at least one embodiment of the present disclosure;

FIG. 2 is a block diagram of an illustrative system capable of providing a selective display system such as depicted in FIG. 1, in accordance with at least one embodiment of the present disclosure.

FIG. 3A is a high-level flow diagram of an illustrative selective display method in which objects represented in an inventory are displayed in a first format in an output generated by a display controller circuit circuit and objects not represented in an inventory are displayed in a second format in the output generated by the display controller circuit circuit, in accordance with at least one embodiment of the present disclosure;

FIG. 3B is an example output generated by the display controller circuit circuit upon execution of the illustrative selective display method of FIG. 3A, in accordance with at least one embodiments of the present disclosure;

FIG. 4 is a high-level flow diagram of an illustrative method of autonomously generating an inventory for use with a selective display method such as that depicted in FIG. 3A, in accordance with at least one embodiment of the present disclosure; and

FIG. 5 is a high-level flow diagram of an illustrative method of autonomously identifying objects based at least in part in a geolocation of a selective display system, in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

A system user may be equipped with a wearable device such as a watch or headset. A selective display system may include display controller circuit circuit in the wearable device. The display controller circuit circuit may develop, generate, or retrieve an inventory that includes objects meeting one or more defined criteria provided by the system user to the selective display system. At times, at least a portion of the object data enabling the display controller circuit circuit to select objects fulfilling the at least one defined criteria provided by the system user for inclusion in the inventory may be stored locally within the selective display system. At other times, at least a portion of the object data enabling the display controller circuit circuit to select objects fulfilling the at least one defined criteria provided by the system user for inclusion in the inventory may be stored remote from the selective display system, for example on one or more servers or similar cloud based storage solutions. In some implementations, a server may access the object data and may generate all or a portion of the inventory.

In some implementations, the selective display system may include one an augmented reality display in which portions of the scene before the system user are obscured or otherwise rendered distinguishable from other portions of the scene. The portions of the scene that are obscured may include those objects before the system user that are not represented in the inventory and the portions of the scene that are unobscured may include those objects before the system user that are represented in the inventory.

In one embodiment, head-mounted display devices may be made available to consumers entering a grocery store. The head-mounted display devices may be separated into a number of groups, each group having a different filtering mod related to food restrictions and preferences such as peanut-free, tree nut-free, gluten-free, vegan, vegetarian, low-sodium, and similar. A customer selects one of the head-mounted display devices and travels through the grocery store. The head-mounted display device selectively filters and blocks those objects not included in the inventory generated by the head-mounted display. The head-mounted display device may determine the location of the consumer in the grocery store using one or more transceivers, such as a global positioning system (GPS) transceiver, or via triangulation using an appropriate number of BLUETOOTH® or cellular signals. An image acquisition device such as a forward facing camera on the head-mounted display device may communicate image data to a display controller circuit circuit that identifies the objects on the store shelves and determines nutrition or other information by comparing the acquired image data against data representative of the store inventory and product information.

A display system to selectively display objects meeting at least one criterion is provided. The selective display system may include, at least one image data acquisition device; at least one output device; at least one circuit communicably coupled to the at least one image data acquisition device and to the at least one output device; and at least one storage device communicably coupled to the at least one circuit and including machine-readable instruction sets that, when executed, cause the circuit to function as a display controller circuit circuit. The display controller circuit circuit captures data representative of at least one scene including a plurality of objects; identifies at least some of the plurality of objects included in the data representative of the at least one scene; determines which of the identified objects included in the at least one scene are represented in an inventory that includes objects meeting at least one defined criterion; and generates a display output including an image of the at least one scene in which identified objects determined as represented in the inventory are presented in a first format and identified objects determined as not represented in the inventory are presented in a second format.

A selective display method is provided. The selective display method may include capturing, by an image acquisition device, data representative of at least one scene including a plurality of objects. The method may further include identifying, by a display controller circuit circuit communicably coupled to the image acquisition device, at least some of the plurality of objects included in the data representative of the at least one scene. The method may also include determining which of the identified objects included in the at least one scene are represented in an inventory that includes objects meeting at least one defined criterion; and generating, by the display controller circuit circuit, an output on a communicably coupled display device, the output including an image of the at least one scene in which identified objects determined as represented in the inventory are presented in a first format and identified objects determined as not represented in the inventory are presented in a second format.

A storage device is also provided. The storage device may include machine-readable instruction sets that, when executed by a processor, cause the processor to function as a specialized display controller circuit. The display controller circuit may cause an image acquisition device to capture data representative of at least one scene including a plurality of objects. The display controller circuit may further identify at least some of the plurality of objects included in the data representative of the at least one scene. The display controller circuit may further determine which of the identified objects included in the at least one scene are represented in an inventory that includes objects meeting one or more defined criteria. The display controller circuit my also generate a display output including an image of the at least one scene in which identified objects determined as represented in the inventory are presented in a first format and identified objects determined as not represented in the inventory are presented in a second format.

A display system for the selective display of objects is provided. The selective display system may include, a means for capturing data representative of at least one scene including a plurality of objects. The selective display system may further include a means for identifying at least some of the plurality of objects included in the data representative of the at least one scene. The selective display system may also include a means for determining which of the identified objects included in the at least one scene are represented in an inventory that includes objects meeting at least one defined criterion and a means for generating an output including an image of the at least one scene in which identified objects determined as represented in the inventory are presented in a first format and identified objects determined as not represented in the inventory are presented in a second format.

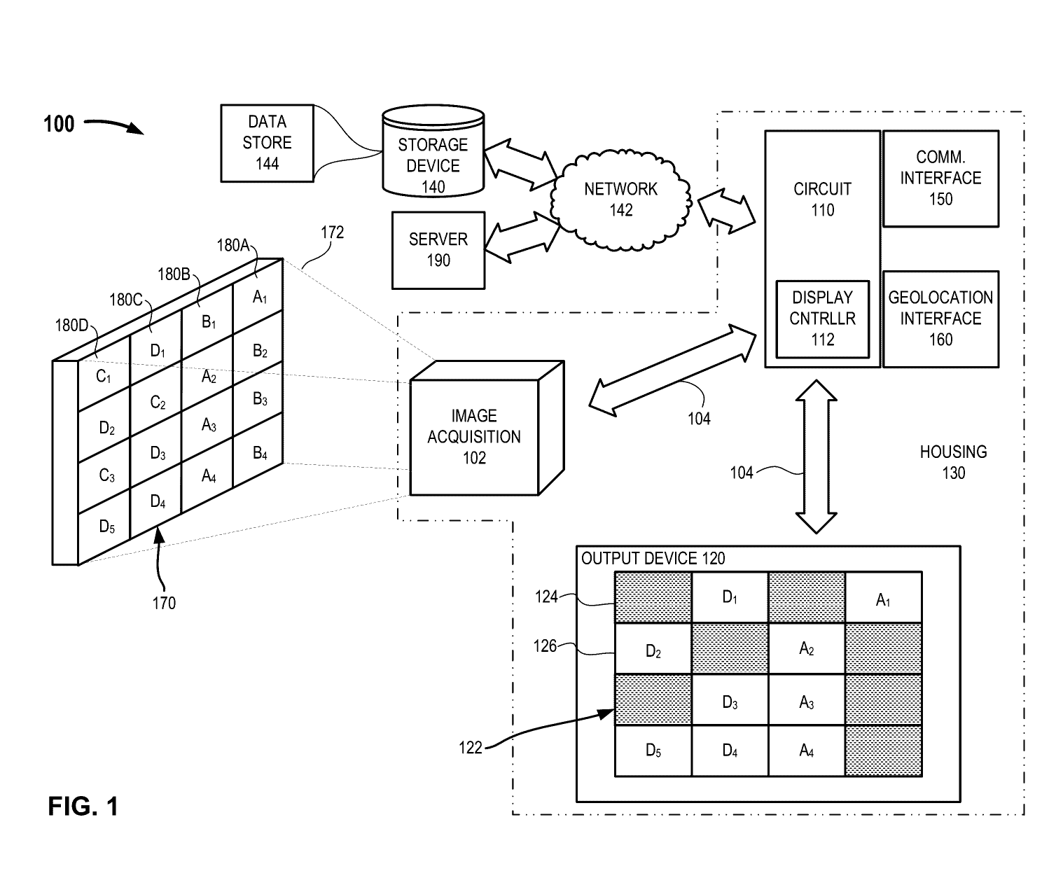

FIG. 1 is a block diagram of an illustrative selective display system 100, in accordance with at least one embodiment of the present disclosure. The selective display system 100 includes at least one image acquisition device 102, at least one circuit 110, at least a portion of which provides a display controller circuit 112, and at least one output device 120. In embodiments, the at least on image acquisition device 102, the circuit 110, and the at least one output device 120 may be disposed in whole or in part in a housing 130. In some embodiments, the selective display system 100 may be incorporated in whole or in part within a housing 130 configured as a wearable device. In some embodiments, the housing 130 may include a portable or wearable computing device, such as Google Glass® (Google, Inc., Mountain View, Calif.), Apple Watch® (Apple, Inc., Palo Alto, Calif.) that includes one or more processors and/or one or more central processing units. In at least one embodiment, the housing 130 may include head-mounted augmented reality glasses.

In some implementations, the selective display system may be communicably coupled to one or more storage devices 140. In some embodiments, at least one storage device 140 may be disposed locally within the housing 130. In other embodiments, at least one storage device 140 may be disposed remote from the housing 130—in such embodiments, the remote storage device 140 may be communicably coupled to the display controller circuit 112 via one or more networks 140. In some implementations, all or a portion of the storage device 140 may be disposed in one or more servers, as exemplified by one or more back-office or cloud based data storage solutions. In such implementations, the display controller circuit 112 may be communicably coupled to the storage device 140 via one or more local area networks (LANs), wireless local area networks (WLANs), wide area networks (WANs), worldwide networks (WWANs), or any combination thereof. In some implementations, the housing 130 may include a wearable device and the storage device 140 may be disposed in a separate device, such as a smartphone, carried by the system user. In such implementations the one or more networks 140 may include a short range communicable coupling using one or more proprietary or industry standard communications protocols such as BLUETOOTH®, or near field communications (NFC).

In various embodiments, at least one communication interface 150 may be communicably coupled to the display controller circuit 112. Such communications interfaces 150 may, on occasion, permit the display controller circuit 112 to communicate with one or more external devices, for example one or more stationary geolocation systems disposed in a commercial or industrial environment. Such communications interfaces 150 may, on occasion, permit the display controller circuit 112 to communicate with one or more other selective display systems 100 and/or one or more other external computing devices such as one or more desktop, laptop, portable, ultraportable, netbook, wearable, handheld, or similar computing devices.

In various embodiments, at least one geolocation interface 160 may be communicably coupled to the display controller circuit 112. Such geolocation interfaces 160 may include one or more global geolocation interfaces, such as one or more global positioning system (GPS), one or more global navigation satellite system (GLONASS) interfaces, or one or more Galileo navigation system (GNSS) interfaces. Such geolocation interfaces 160 may, in addition or alternatively, include one or more terrestrial geolocation interfaces, such as one or more cellular interfaces permitting triangulation of geolocation based on cellular transmission towers. Such geolocation interfaces 160 may include one or more interfaces capable of integrating both satellite and terrestrial geolocation interfaces, such as one or more differential GPS (DGPS) interfaces or one or more assisted GPS (AGPS) interfaces which combine both terrestrial and satellite geolocation technologies.

In some implementations, the at least one geolocation interface 160 may include one or more unique identifiers communicably coupled to one or more transceivers. In such an implementation, an array of navigational beacons may be placed in defined locations throughout an area such as a commercial or industrial establishment. The navigational beacons may, periodically or aperiodically, interrogate all of the geolocation interfaces 160 within range of the beacon and, using triangulation, locate each of the selective display systems 100 within the commercial or industrial establishment. Such selective display system location and identification information may be communicated to display controller circuit 112. Such selective display system location and identification information may be communicated to one or more remote devices, such as one or more servers 190.

The at least one image acquisition device 102, the at least one output device 120, the data store 140, the at least one communication interface 150, and the at least one geolocation interface 160 may be communicably coupled together via one or more communications links, such as one or more buses 104. In use, the selective display system 100 may be used to acquire data representative of an image of a scene 170 that appears within at least a portion of the field of view 172 of the at least one image acquisition device 102. Image data representative of any number of objects 180A-180D (collectively, “objects 180”) may be included in the image data representative of the scene 170 received by the display controller circuit 112. Such objects may include, but are not limited to, external commercial product packaging, boxes, cartons, drums, or any other current or future product container, canister, or similar.

In operation, the selective display system 100 may acquire image data representative of the scene 170 that falls within all or a portion of the field of view of the at least one image acquisition device 102. Such may include image data representative of a number of still images of the scene 170 or image data representative of a video or a sequential number of still images obtained at a defined frame rate of the scene 170. Some or all of the acquired image data may be forwarded or otherwise communicated to the display controller circuit 112.

At least a portion of the image data received by the display controller circuit 112 may include image data of some or all of the objects 180. Illustrative, non-limiting examples of such objects 180 may include consumer goods arranged on store shelves, boxes or other containers arranged on warehouse shelves, or other similar instances. The image data received from the at least one image acquisition device 102 may In some embodiments, based at least in part on the image data received from the at least one image acquisition device 102, the display controller circuit 112 may identify at least a portion of the objects 180 included in the received image data. In other embodiments, based at least in part on the image data received from the at least one image acquisition device 102, the at least one server 190 may identify at least a portion of the objects 180 included in the received image data.

At times, the display controller circuit 112 and/or the at least one server 190 may be unable to identify one or more objects 180 appearing in the field-of-view 172. Objects 180 may be unidentifiable for any one of a number of reasons, including but not limited to, a missing, obscured, or damaged label, misplaced objects (i.e., objects from one geographic location moved to a different geographic location that is not logically associated with the respective object), newly added objects, changes in object packaging, etc. In such instances, the display controller circuit 112 and/or the at least one server 190 may handle the unidentified objects as an exception and may provide an unobscured image of the respective unidentified objects 180. In some implementations, the display controller circuit 112 and/or the at least one server 190 may provide one or more unidentified object designators, for example by altering or adjusting one or more parameters of the unidentified objects 180 to visually designate those objects as “unidentified” to the system user. Example of such unidentified object designators may include but are not limited to: highlighting the respective unidentified objects, providing a text descriptor in the display designating the unidentified objects as “UNIDENTIFIED” or “INFORMATION NOT AVAILABLE,” altering one or more colors sizes, shapes, or other object physical attributes, or combinations thereof.

In other embodiments, the display controller circuit 112, the at least one server 190, or any combination thereof, may identify some or all of the objects 180 based at least in part on the geolocation data received from the geolocation interface 150, the image data received from the at least one image acquisition device 102, or combinations thereof.

In one implementation, the at least one server 190 may include one or more data stores or the display controller circuit 112 may access one or more data stores 140 that include data indicative of various consumer products available at a particular geolocation within a commercial establishment indexed or otherwise organized based at least in part on the geolocation of the objects 180 in the establishment. In such an implementation, the at least one geolocation interface 160 may provide the at least one server with data indicative of the geolocation of the selective display system 100 and the at least one server 190 may respond with data indicative of the objects 180 visible in the field-of-view 172 of the at least one image acquisition device 102.

In another implementation, the at least one server 190 or the display controller circuit 112 may include one or more object detection and identification systems able to identify objects 180. Such identification may, in some embodiments, be based in whole or in part on one or more physical aspects of the objects 180 (shape, size, color, patterning, optical character recognition, etc.). Such identification may, in some embodiments, be based in whole or in part on one or more encoding schemes appearing on or proximate the objects 180 (bar codes, two-dimensional matrix codes, three-dimensional matrix codes, etc.).

After identifying the objects 180, the at least one server 190, the at least one display controller circuit 112, or any combination thereof may compare the identified objects 180 against an inventory. In embodiments, the objects 180 included in the inventory may include objects 180 meeting at least one defined criterion. The defined criterion may be determined based at least in part on one or more inputs provided by a system user to the selective display system 100. Such inputs may include data indicative of one or more preferences of the system user. For example, a system user may provide an input indicative of a preference for gluten free products, kosher products, Halal products, etc.

In some implementations, inventories meeting broad categories of user preferences (vegetarian, vegan, Kosher, Halal, etc.) may be stored in the selective display system 100 itself and the selective display system 100A associated with each broad category may be distinguishable from all other selective display systems 100B-100n. For example, vegetarian selective display systems 100A may be disposed in a first color housing, vegan selective display systems 100B may be disposed in a second color housing, Kosher selective display systems 100C may be disposed in a third color housing, and Halal selective display systems 100D may be disposed in a fourth color housing. Inventories may be built using any number or combination of criteria. For example, inventories associated with a particular ethnicity, a particular nationality, a particular culture, a particular diet, and similar may be similarly provided.

As the system user passes objects 180, various objects 180 within the field-of-view 172 of the at least one image acquisition device 102 are identified and compared to the objects represented on the inventory. Such identification and comparison may be performed by the display controller circuit 112, the at least one server 190, or any combination thereof. An output, such as a display 122, may present the identified objects 180 that are represented in the inventory in a first format. In embodiments, the first format may simply be an unobscured or in-focus depiction 126 of the respective objects 180 in the display 122. In other embodiments, the first format may enhance one or more aspects of the identified objects 180 in the display 122 (increase brightness, increase contrast, enhance colors, surround with “marching ants,” etc.). The output may present the identified objects 180 that are not represented in the inventory in a second format that differs from the first format. In embodiments, the second format may simply include an obscured or out of focus depiction 124 of the objects 180 in the display 122. In other embodiments, the second format may reduce or obscure one or more aspects of the identified objects 180 in the display (decrease brightness, reduce contrast, mute colors, etc.).

In embodiments, as objects 180 are identified and the presence or absence of the identified objects in the inventory confirmed, the display controller circuit 112 may alter one or more parameters of a head-mounted augmented reality glasses such that identified objects 180 represented in the inventory are clearly visible (i.e., are unobscured) through the lenses of the augmented reality glasses (i.e., are displayed in the first format) that function as the display 122, while the identified objects 180 NOT represented in the inventory are NOT clearly visible (i.e., are obscured) through the lenses of the augmented reality glasses (i.e., are displayed in the second format). In other embodiments, the display controller circuit 112 may provide a clear line-of-sight through an augmented reality lens to those identified objects 180 determined as represented in the inventory and an obscured line-of-sight through an augmented reality lens to those identified objects 180 determined as not represented in the inventory.

The image acquisition device 102 may include any number or combination of systems and devices capable of acquiring an image of a scene 170 in the field-of-view 172 of the image acquisition device 102 and converting the image into image data that can be communicated to one or more external devices such as the display controller circuit 112. In some implementations, the at least one image acquisition device 102 may include one or more sensors capable of acquiring image data in the visible electromagnetic spectrum of from about 390 nanometers (nm) to about 700 nm. In some implementations, the at least one image acquisition device 102 may include one or more sensors capable of acquiring image data in the non-visible electromagnetic spectrum of less than about 390 nanometers (nm) or greater than about 700 nm. In some implementations, the at least one image acquisition device 102 may include any current or future developed device capable of acquiring an image of a scene 170 and converting the image to an analog or digital signal. Example image acquisition devices 102 may include, but are not limited to, one or more charge coupled device (CCD) image sensors or one or more complementary metal oxide semiconductor (CMOS) image sensors. The image acquisition device 102 may have a resolution of about 1 megapixel (MP) or greater; about 3 MP or greater; about 5 MP or greater; about 10 MP or greater; about 20 MP or greater; about 30 MP or greater; or about 50 MP or greater.

The at least one circuit 110 may include any combination or number of electronic components and semiconductor devices capable of being coupled in a manner facilitating the execution of machine-readable instruction sets that cause at least a portion of the at least one circuit to provide and/or function as a particular and specialized display controller circuit 112. In some implementations, the at least one circuit 110 may include any current or future developed hardwired controller or similar device capable of executing machine-readable instruction sets. In some implementations, the at least one circuit 110 may include any current or future developed configurable circuit or similar devices. Example, non-limiting circuits 110 may include, but are not limited to: a programmable gate array (PGA); a field programmable gate array (FPGA); a digital signal processor (DSP); a processor; a microprocessor; and the like. In at least some implementations, at least a portion of the electronic components and semiconductor devices disposed within the at least one circuit 110 may be configured to provide the display controller circuit 112. One or more conductors 104 communicably couple the at least one image acquisition device 102 to the circuit 110 and/or display controller circuit 112. In at least some implementations, the one or more conductors 104 may form all or a portion of one or more serial or parallel data buses within the selective display system 100.

The at least one output device 120 may include any combination or number of devices capable of providing a human perceptible output from which a system user is able to discern identified objects 180 that are represented in an inventory that includes objects 180 meeting at least one defined criterion from identified objects 180 that are not represented in the inventory. In at least some implementations, the at least one output device 120 may include one or more display devices. The at least one output device 120 may receive one or more output signals generated by the display controller circuit 112. The at least one display device 120 may include any current or future developed display device. Example output devices 120 may include, but are not limited to, one or more light emitting diode (LED) displays, one or more liquid crystal (LCD) displays, one or more organic LED (OLED) displays, or one or more polymer LED (PLED) displays. In some implementations, the at least one display device 120 may include one or more wearable display devices 120, such as a GOOGLE GLASS® display device (Google, Inc., Mountain View, Calif.). The at least one output device 120 may have a resolution of 480p, 480i, 720p, 720i, 1080p, or 1080i. The at least one output device 120 may have an aspect ratio of 5:4, 4:3, 16:9, or 16:10. In some implementations, the at least one display device 120 may include one or more augmented reality devices that include at least one lens through which at least a portion of the scene 170 is visible.

The housing 130 may include any structure capable of accommodating all or a portion of the at least one image acquisition device 102, the at least one circuit 110 and the at least one output device 120. In some implementations, the housing 130 may additionally accommodate all or a portion of the communications interface 150 and/or all or a portion of the geolocation interface 160. In embodiments, all or a portion of the housing 130 may be of a form factor that is conformable to at least a portion of the human anatomy such that the selective display system 100 may be worn by the system user. In embodiments, the housing 130 may have attachments or fixtures that facilitate attachment to the human anatomy.

The at least one storage device 140 may include any number or combination of devices and systems capable of retaining digital data in a nontransitory format. The at least one storage device 140 may include any current or future data storage technology. Example storage devices 140 may include, but are not limited to, one or more solid state drive (SSD); one or more rotating magnetic drive (HDD); one or more electrostatic storage devices; one or more electromagnetic storage devices; one or more optical storage devices; one or more quantum storage devices; one or more atomic storage devices; or combinations thereof. In some implementations, the at least one storage device 140 may be at least partially disposed in the housing 130 (i.e., local to the housing 130). In some implementations, the at least one storage device 140 may be disposed remote from the housing 130. In such implementations, the at least one storage device 140 may include a cloud-based storage device communicably coupled via the network 142 and communications interface 150 to the display controller circuit 112.

At least one data store 144 may be stored or otherwise retained in or on the at least one storage device 140. In embodiments, the at least one data store 144 may include data useful for identifying the objects 180 by the display controller circuit 112 or the server 190. In embodiments, the at least one data store 144 may include information in the form of geolocations logically associated with each of some or all of the objects 180. In some embodiments, the at least one data store 144 may include information in the form of product details logically associated with each of some or all of the objects 180. In some embodiments, the at least one data store 144 may include information in the form of inventories, each of which includes objects 180 that meet one or more user-defined or system-defined criteria. In some implementations, the display controller circuit 112 may perform one or more logical operations, such as one or more lookup operations, to identify objects 180 included in image data provided by the at least one image acquisition device 102. In some implementations, the display controller circuit 112 may perform one or more logical operations, such as one or more lookup operations, to identify objects 180 represented on one or more inventories.

The at least one communications interface 150 may include any number or combination of devices and/or systems capable of bidirectionally exchanging information in the form of analog or digital data with one or more device external to the selective display system 100. The at least one communications interface 150 may communicate with external devices either directly or via one or more intervening networks or similar data transport structures. The at least one communications interface 150 may communicate with the one or more external devices via any current or future proprietary communication protocol or any current or future industry standard communication protocol. Example communication protocols may include, but are not limited to, BLUETOOTH®; IEEE 802.11 (latest version—Wi-Fi); ZigBee; Near Field Communication (NFC); and similar.

The at least one geolocation interface 160 may include any number or combination of devices and/or systems capable of identifying a location of the selective display system 100. In some implementations, the at least one geolocation interface 160 may include one or more transceivers capable of identifying and generating data representative of the location of the selective display system 100 via one or more satellite networks (GPS, GLONASS, Galileo, etc.). In some implementations, the at least one geolocation interface 160 may include one or more transceivers capable of identifying and generating data representative of the location of selective display system 100 using one or more terrestrial beacons. For example, using a plurality of cellular communications towers to triangulate a geolocation of the selective display system 100. In at least some implementations, the at least one geolocation interface may communicate the data representative of the location of the selective display system 100 to the display controller circuit 112, the at least one server 190, or any combination thereof.

The objects 180 may include any size, shape, configuration, or number of items proximate or in the vicinity of the selective display system 100. Although described herein within the context of a grocery store or warehouse, such embodiments are intended to simplify the discussion and are not intended as limitations on the employment of the selective display system 100 as described herein. The objects may be arranged in any organized or random manner. As depicted in FIG. 1, multiples of four different objects, labeled A, B, C, and D (corresponding to 180A, 180B, 180C, and 180D, respectively) may be disposed in the scene 170 within the field-of-view 172 of the at least one image acquisition device.

By way of example, objects 180A and 180D may be objects that meet one or more defined criteria while objects 180B and 180C may be objects that do not meet the one or more defined criteria. The image data acquired by the at least one image acquisition device 102 may be communicated to the display controller circuit 112. In some implementations, the display controller circuit 112 identifies the objects 180A-180D using the image data supplied by the at least one image acquisition device 102. In such implementations, the display controller circuit 112 determines that objects 180A and 180D are represented in the inventory while objects 180B and 180C are not represented in the inventory. The display controller circuit 112 generates a display output in which the scene 170 is reproduced with objects 180A and 180D displayed in a first (i.e., unobscured) format 126 and objects 180B and 180C displayed in a second (i.e., obscured) format 124.

In embodiments, each of the objects 180 may be physically different, such as having different markings, colors, shapes, sizes, and geometries. In such embodiments, the display controller circuit 112 and/or the server 190 may use these physical differences to uniquely identify the respective object 180. In other embodiments, each of the objects 180 may include one or more identifying or distinguishing markings that may or may not be apparent in the visible electromagnetic spectrum. For example, each of the objects 180 may include bar codes or matrix codes that uniquely identify the respective object 180. In such embodiments, the display controller circuit 112 and/or the server 190 may use these identifying or distinguishing markings to uniquely identify the respective object 180. At times such identifying markings may be in a format readable in a non-visible portion of the electromagnetic spectrum, for example, the infrared portion of the electromagnetic spectrum. Such advantageously leverages the ability of many image acquisition devices to capture images in the near-infrared portion of the electromagnetic spectrum.

The at least one server 190 may include one or more devices or systems disposed remote from the selective display system 100 and communicably coupled to the selective display system 100 via one or more networks 142. In at least some implementations, the at least one server 190 may be disposed local to the objects 180, but remote from the selective display system 100 (e.g., a back-office system). In at least some implementations, the at least one server 190 may be disposed remote from the objects 180 and the selective display system 100 (e.g., a “cloud-based” server). In some implementations, the at least one server 190 may include all or a portion of the at least one storage device 140.

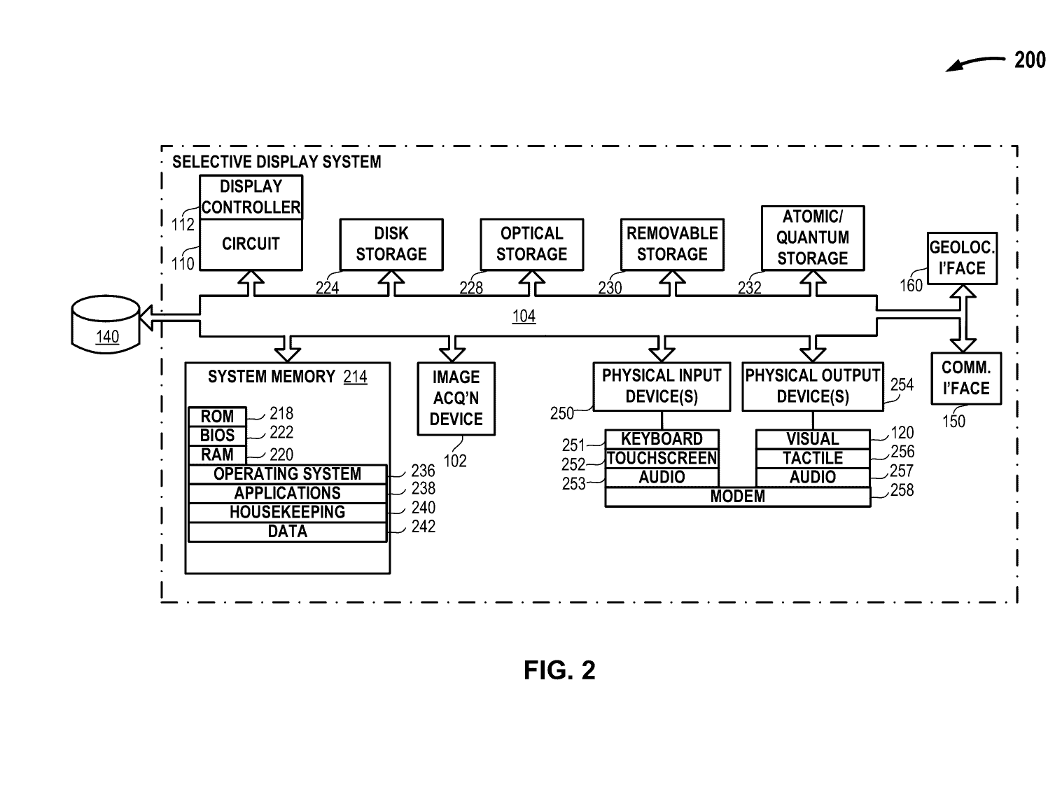

FIG. 2 and the following discussion provide a brief, general description of the components forming an illustrative system 200 that includes an embodiment of the selective display system 110 described in detail above with regard to FIG. 1, in accordance with at least one embodiment of the present disclosure. Although not required, some portion of the embodiments will be described in the general context of machine-readable or computer-executable instruction sets, such as program application modules, objects, or macros being executed by the system 200. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like. The embodiments can be practiced in distributed computing environments where tasks or sub-sets of tasks may be performed by remote processing devices, which are linked through a communications network. In a distributed computing environment, tasks or task sub-sets may be located in both local and remote memory storage devices.

The system 200 includes one or more circuits 110, and may include one or more conductors or buses 104 that communicably couple various system components including a system memory 214 to the one or more circuits 110. In embodiments, the one or more conductors 104 that interconnect at least some of the system components may employ any known bus structures or architectures. The one or more circuits 110 may execute one or more sets of machine-readable instructions that cause the one or more circuits to provide at least one specialized or particular display controller circuit 112. The at least one display controller circuit 112 may include any number, type, or combination of devices. At times, the at least one display controller circuit 112 may be implemented in whole or in part in the form of semiconductor devices such as diodes, transistors and electrical components such as inductors, capacitors, and resistors. Such an implementation may include, but is not limited to any current or future developed single- or multi-core processor or microprocessor, such as: one or more systems on a chip (SOCs); central processing units (CPUs); digital signal processors (DSPs); graphics processing units (GPUs); application-specific integrated circuits (ASICs), field programmable gate arrays (FPGAs), and the like. In embodiments, the at least one display controller circuit 112 may be implemented in whole or in part as a hardwired circuit. In embodiments, the at least one display controller circuit 112 may be implemented in whole or in part using one or more multipurpose processors, microprocessors, controllers, or similar. Unless described otherwise, the construction and operation of the various blocks shown in FIG. 2 are of conventional design. As a result, such blocks need not be described in further detail herein, as they will be understood by those skilled in the relevant art.

The system memory 214 may include read-only memory (“ROM”) 218 and random access memory (“RAM”) 220. A portion of the ROM 218 may contain a basic input/output system (“BIOS”) 222. The BIOS 222 may provide basic system functionality, for example by causing the one or more circuits to load the machine-readable instruction sets that cause at least a portion of the one or more circuits 212 to function as the thermal management controller 150. The system 200 may include one or more communicably coupled data storage devices, such as one or more magnetic storage devices 224, optical storage devices 228, solid-state electromagnetic storage devices 230, atomic or quantum storage devices 232, or combinations thereof.

The system memory 214 may include any number of interfaces or controllers (not shown) that communicably couple the respective storage device or system to the one or more conductors 216, as is known by those skilled in the art. The storage devices may contain machine-readable instruction sets, data structures, program modules, and other data useful to the display controller circuit 112. In some instances, one or more storage devices 140 may also externally communicably couple to the system 200 via one or more networks 142.

Machine-readable instruction sets 238 and other instruction sets 240 may be stored in whole or in part in the system memory 214. Such instruction sets 238, 240 may be transferred from the storage device 202 and stored in the system memory 214 in whole or in part when executed by the display controller circuit 112. The machine-readable instruction sets 238 may include one or more instruction sets capable of providing the selective display capabilities described herein.

For example, one or more machine-readable instruction sets 238 may cause the display controller circuit 112 to detect and identify objects 180 that appear in the image data acquired from the at least one image acquisition device 102. One or more machine-readable instructions may cause the display controller circuit 112 to generate, create, select, or retrieve an inventory that includes objects 180 meeting one or more defined criterion provided by a system user. One or more machine-readable instruction sets 238 may cause the display controller circuit 112 determine whether the identified objects 180 included in the image data are represented in the inventory. One or more machine-readable instruction sets 238 may cause the display controller circuit 112 to generate a display output in which objects 180 represented in the inventory are displayed in a first format on the display device 120. One or more machine-readable instruction sets 238 may cause the display controller circuit 112 to generate a display output in which objects 180 not represented in the inventory are displayed in a second format on the display device 120. In embodiments, one or more machine-readable instruction sets 238 may cause the display controller circuit 112 to identify objects 180 included in the scene 170 using geolocation information provided by the geolocation interface 160.

System users may provide, enter, or otherwise supply information and/or commands (e.g., defined object selection criterion) to the system 200 using one or more communicably coupled physical input devices 250 such as a text entry device 251 (e.g., keyboard), pointer 252 (e.g., mouse, touchscreen), or audio 253 input device. Some or all of the physical input devices 250 may be physically and communicably coupled to a system housing. In some implementations, the selective display system 100 chosen by the user may, itself, provide an input to the display controller circuit 112 that includes data indicative of the at least one defined object selection criterion. For example, in a grocery store environment a number of different housing colors may be used to represent predefined object inventories (e.g., red housing=vegetarian object inventory; orange housing=vegan object inventory; blue housing=Kosher object inventory; green housing=Halal object inventory; yellow housing=low salt object inventory; purple housing=gluten-free object inventory, and so on).

System users may receive output generated, at least in part, by display controller circuit 112 via one or more physical output devices 254. In at least some implementations, the physical output devices 254 may include, but are not limited to, one or more visual display devices 120; one or more tactile output devices 256; one or more audio output devices 258, or combinations thereof. Some or all of the physical input devices 250 and some or all of the physical output devices 254 may be communicably coupled to the display controller circuit 112 via one or more wired or wireless interfaces.

For convenience, the communication interface 150, the circuit 110, the display controller circuit 112, the system memory 214, the physical input devices 250 and the physical output devices 254 are illustrated as communicatively coupled to each other via the one or more conductors or via a bus 104, thereby providing connectivity between the above-described components. In alternative embodiments, the above-described components may be communicatively coupled in a different manner than illustrated in FIG. 2. For example, one or more of the above-described components may be directly coupled to other components, or may be coupled to each other, via one or more intermediary components (not shown). In some embodiments, all or a portion of the one or more conductors or buses 104 may be omitted and the components are coupled directly to each other using suitable wired or wireless connections.

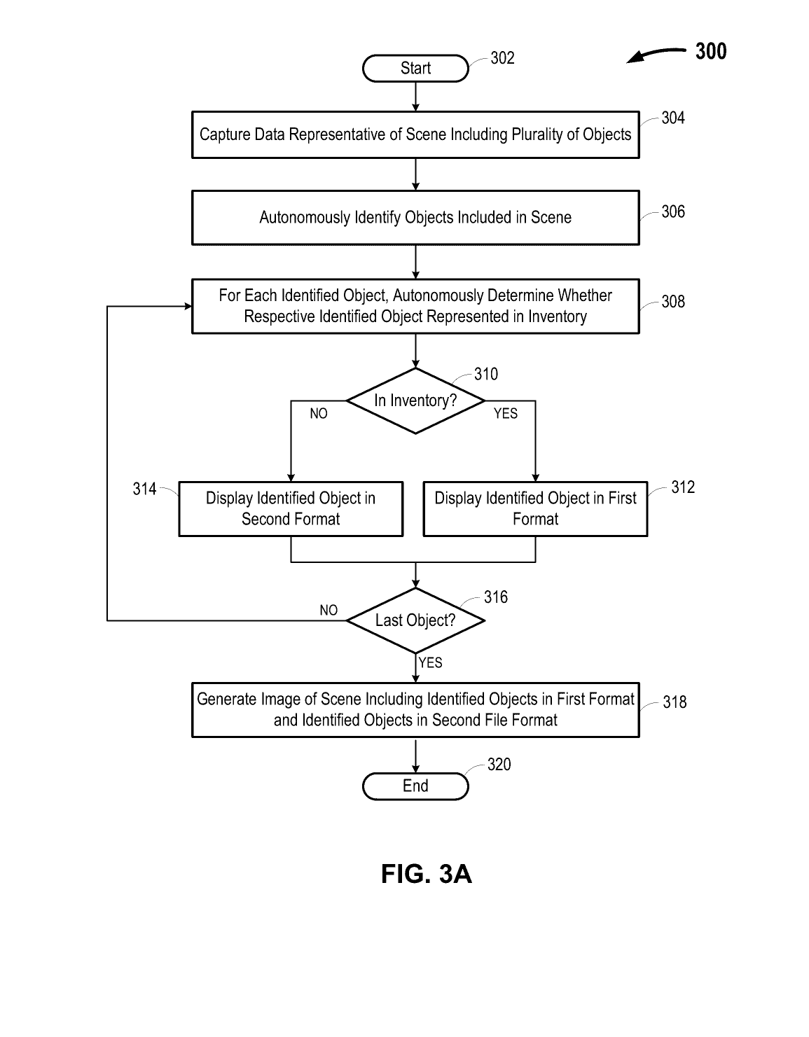

FIG. 3 is a high-level flow diagram of an illustrative method 300 of providing a display in which objects 180 represented in an inventory are presented in a first format and objects not represented in an inventory are presented in a second format, in accordance with at least one embodiment of the present disclosure. Providing a system user with the capability to filter out irrelevant objects 180 beneficially permits the system user to focus on those objects 180 that possess one or more defined criteria. The one or more defined criteria may be determined using one or more inputs provided by the system user. In some embodiments, a system user may simply provide the selective display system 100 with an input that instructs the system 100 to display objects meeting one or more defined criteria. Such inputs may be inclusionary, for example, “Show me all of the products that include whole wheat as an ingredient.” Such inputs may be exclusionary, for example, “Exclude objects containing artificial sweeteners.” The method 300 commences at 302.

At 304, the at least one image acquisition device 102 captures or otherwise acquires data representative of a scene 170 within all or a portion of the field-of-view 172 of the at least one image acquisition device 102. In implementations, at least a portion of the acquired image data may be obtained in a human-visible electromagnetic spectrum of from about 390 nanometers (NM) to about 700 nm. In some implementations, at least a portion of the acquired image data may be obtained in the human-invisible electromagnetic spectrum of less than about 390 nm or greater than about 700 nm. In embodiments, the at least one image acquisition device 102 may acquire and communicate data representative of a number of still images of the scene 170. In some embodiments, the at least one image acquisition device 102 may acquire and communicate data representative of a video or a number of fixed frame rate sequential images of the scene 170. The at least one image acquisition device 102 communicates or transmits the data representative of the scene 170 to the display controller circuit 112.

At 306, any number of objects 180 appearing in the scene 170 are autonomously identified. In some implementations, the display controller circuit 112 may identify some or all of the objects 180 appearing in the scene 170. In some implementations, image data may be transferred to the server 190 and the server 190 may identify some or all of the objects 180 appearing in the scene 170. In some implementations, the server 190 and the display controller circuit 112 may collaboratively identify at least a portion of the objects 180 included in the image data of the scene 170.

In some implementations, at least a portion of the objects 180 may be identified using one or more physical characteristics such as size, shape, color, text or the like that characterize and uniquely identify the respective object 180. In such implementations, the storage device 140 may hold, retain, or otherwise include one or more data stores 144 in which data indicative of the physical parameters characterizing an object 180 are logically associated with the respective object 180. The server 190 and/or the display controller circuit 112 may compare the physical parameters of the objects 180 included in the image data supplied by the at least one image acquisition device with the physical parameters in the data store 144 to identify at least a portion of the objects 180.

In some implementations, at least a portion of the objects 180 may be identified using one or more codes, icons, or similar devices appearing proximate or an external surface of the object 180. Such codes or similar devices may include, but are not limited to, codes such as bar codes, matrix codes or the like that appear proximate to the object or are included on one or more labels, tags, or similar fixtures carried by the object 180. In such implementations, the storage device 140 may hold, retain, or otherwise include one or more data stores 144 in which data indicative of the codes, icons, or similar devices proximate the object 180 or affixed to an external surface of the object 180 are logically associated with the respective object 180. The server 190 and/or the display controller circuit 112 may compare one or more codes, icons, or similar devices included in the image data supplied by the at least one image acquisition device with the one or more codes, icons, or similar devices in the data store 144 to identify at least a portion of the objects 180.

In some implementations, at least a portion of the objects may be identified based at least in part on the geolocation of the selective display system 100. In such implementations, the storage device 140 may hold, retain, or otherwise include one or more data stores 144 in which data indicative of the geolocation of an object 180 is logically associated with the respective object 180. The server 190 and/or the display controller circuit 112 may compare the geolocation of the selective display system 100 and the image data supplied by the at least one image acquisition device with the geolocation of objects 180 stored or otherwise retained in the data store 144 to identify at least a portion of the objects 180.

At 308, for each identified object 180 appearing in the scene 170, the selective display system 100 autonomously determines whether the respective identified object 180 is represented on an inventory. In some implementations, the display controller circuit 112 may determine whether the respective identified object 180 is represented on an inventory. In some implementations, the server 140 may determine whether the respective identified object 180 is represented on an inventory.

In embodiments, the identified object 180 may be explicitly represented in the inventory. For example, the inventory may include data indicative of “Warehouse item having a particular UPC code.” In such instances, the selective display system 100 may compare the UPC codes logically associated with the identified objects 180 to determine whether a specific object 180 is included in the scene 170.

In other embodiments, the identified object 180 may be implicitly represented in the inventory. For example, the inventory may include data indicative of “Objects containing less than 200 calories per serving.” In such instances, the selective display system 100 may compare the caloric content of single servings of each object 180 appearing in the scene and display in the first format only those objects having less than 200 calories per serving.

At 310, the selective display system 100 autonomously determines whether the identified object 180 is represented on the inventory. If, at 310, the display controller circuit 112 determines the identified object 180 is represented on the inventory, at 312 the display controller circuit 112 generates an output that includes the identified object 180 in a first format. If at 310, the display controller circuit 112 determines the identified object 180 is not represented on the inventory, at 314 the display controller circuit 112 generates an output that includes the identified object 180 in a second format. The selective display system 100 performs this determination for each identified object 180 included in the scene. If at 316, it remains to be determined whether additional identified objects 180 are represented on the inventory, the method 300 returns to 308.

At 318, the display controller circuit 112 generates an output for display on the display device 120. Identified objects 180 represented in the inventory are displayed in a first format (e.g., unobscured and in focus) and identified objects not represented in the inventory are displayed in a second format (e.g., obscured and out-of-focus). FIG. 3B provides an example display output 122 that includes identified objects represented in the inventory 126 in the first format (i.e., unobscured and visible) and identified objects 180 not represented in the inventory 124 in the second format (i.e., obscured and not visible). The method 300 concludes at 320.

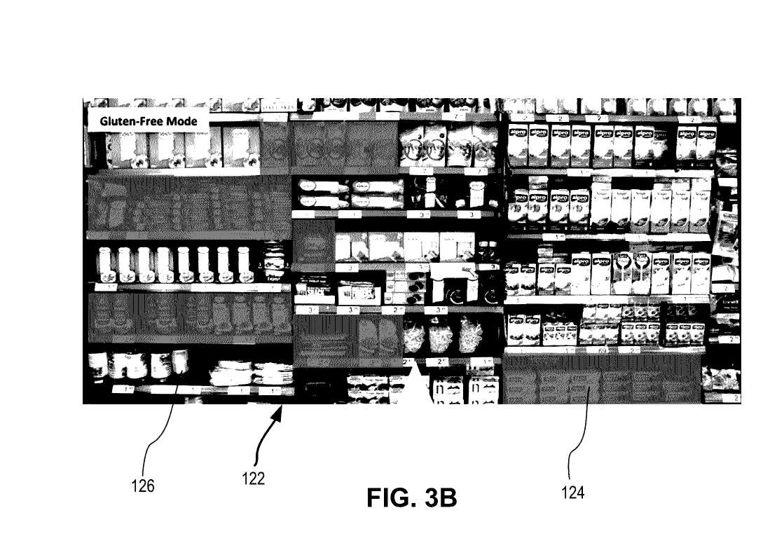

FIG. 4 is a high-level flow diagram of an illustrative method 400 of generating an inventory, in accordance with at least one embodiment of the present disclosure. The selective display system 100 may autonomously generate an inventory that includes a number of identified objects meeting one or more defined criteria. In embodiments, the selective display system 100 generates the inventory based on one or more system user inputs that provide the selective display system 100. In embodiments, such user inputs may be in the form of one or more inputs provided via an input device such as a touchscreen or keyboard. In embodiments, such user inputs may be of the form of one or more inputs provided based at least in part on one or more actions taken by the system user. For example, the system user may be presented with a number of housings 130, each corresponding to a different input. By selecting a particular housing 130, the selective display system identifies the inventory logically associated with the selected housing 130. The method 400 commences at 402.

At 404, the selective display system 100 receives input from a system user that identifies one or more defined criterion used by the system to generate an inventory. In some implementations, the input may be provided using one or more input devices such as a keyboard or touchscreen. In such implementations, the system user may provide input by ticking radio buttons or similar graphical indicators, by providing text based input using a physical or virtual keyboard, or combinations thereof. In such implementations, the system user may provide inputs such as desired class of identified objects 180, a specific identified object 180, or a single identified object or a class of identified objects that possess one or more defined criterion.

In some implementations, the input may be provided based upon one or more actions taken by the system user. In such implementations, an act performed by the system user, such as selecting a particular selective display system 100 that is logically associated with a particular identified object 180 or class of identified objects 180, may serve as an input to the selective display system 100.

At 406, the selective display system 100 autonomously generates an inventory based in whole or in part on the input provided by the system user at 404. In embodiments, the server 190 may generate all or a portion of the inventory. In other embodiments, the display controller circuit 112 may generate all or a portion of the inventory. In some implementations, the server 190 and/or the display controller circuit 112 may perform one or more logical operations on one or more data stores 144 when populating the inventory with objects 180. For example, in response to an input indicative of objects 180 containing “whole wheat” as an ingredient, the server 190 and/or the display controller circuit 112 may perform one or more searches or similar look-up operations using one or more data stores containing ingredient information for each of the objects 180 to identify and populate the inventory with those objects 180 logically associated with (i.e., containing) whole wheat as an ingredient. The method 400 concludes at 408.

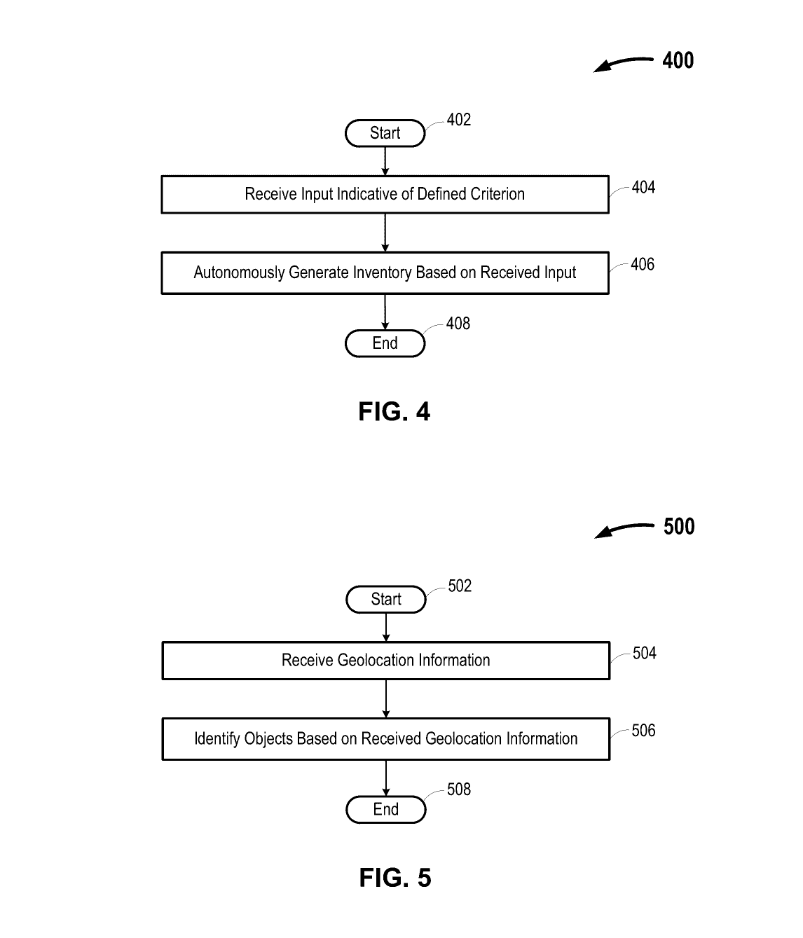

FIG. 5 is a high-level flow diagram of an illustrative method 500 of identifying objects 180 based at least in part on the geolocation of the selective display system 100, in accordance with at least one embodiment of the present disclosure. The selective display system 100 may include one or more geolocation interfaces 160. The one or more geolocation interfaces 160 may provide the display controller circuit 112 with information or data indicative of an absolute geolocation (e.g., longitude/latitude/elevation) or information or data indicative of a relative geolocation (e.g., location in a warehouse, industrial facility, or commercial facility). Such geolocation information may be helpful in identifying objects 180 appearing in the scene 170, particularly when a data store 144 containing data representative of object identities logically associated with data representative of a geolocation of the respective object exists. The method 500 commences at 502.

At 504, the display controller circuit 112 receives data indicative of an absolute geolocation or a relative geolocation of the selective display system 100. In embodiments, the selective display system 100 may include at least one of a global positioning system (GPS) transceiver, a global navigation satellite system (GLONASS) transceiver, or a Galileo transceiver that may provide absolute geolocation data to the display controller circuit 112. In other embodiments, the selective display system 100 may include a short range radio frequency (RF) transceiver capable of detecting stationary beacons in the vicinity of the selective display system 100. In such embodiments, the circuit 110 or the display controller circuit 112 may triangulate a geolocation corresponding to the location of the selective display system 100 with respect to the beacons. Example, non-limiting, RF transceivers capable of providing geolocation information include any current or future cellular transceiver (GSM, CDMA, LTE, 4G, 3G, etc.), any current or future radio frequency identification (RFID) transceiver, any current or future BLUETOOTH® transceiver, and the like.

At 506, the selective display system 100 autonomously identifies objects 180 based at least in part on the geolocation data provided by the at least one geolocation interface 160. In some implementations, the display controller circuit 112 may perform one or more logical operations on a data store 144 containing data indicative of a respective geolocation logically associated with each object 180 to identify some or all of the objects included in the scene 170. In some implementations, the server 190 may perform one or more logical operations on a data store 144 containing data indicative of a respective geolocation logically associated with each object 180 to identify some or all of the objects included in the scene 170. The method 500 concludes at 508.

The following examples pertain to embodiments that employ some or all of the described reverse breakdown diode trigger circuit apparatuses, systems, and methods described herein. The enclosed examples should not be considered exhaustive, nor should the enclosed examples be construed to exclude other combinations of the systems, methods, and apparatuses disclosed herein and which are not specifically enumerated herein.

According to example 1, there is provided a display system to selectively display objects meeting at least one criterion. The selective display system may include at least one image data acquisition device, at least one output device, and at least one display controller circuit. The at least one display controller circuit may capture data representative of at least one scene including a plurality of objects. The at least one display controller circuit may further identify at least some of the plurality of objects included in the data representative of the at least one scene. The at least one display controller circuit may further determine which of the identified objects included in the at least one scene are represented in an inventory that includes objects meeting at least one defined criterion. The at least one display controller circuit may further generate a display output including an image of the at least one scene in which identified objects determined as represented in the inventory are presented in a first format and identified objects determined as not represented in the inventory are presented in a second format.

Example 2 may include elements of example 1 where the at least one image data acquisition device comprises at least one optical data acquisition device capable of collecting image data in the visible spectrum of from about 390 nanometers (nm) to about 700 nm.

Example 3 may include elements of example 2 where the at least one image data acquisition device comprises at least one optical data acquisition device capable of collecting image data in at least a portion of the electromagnetic spectrum of less than about 390 nm or greater than about 700 nm.

Example 4 may include elements of example 1 where the display output including an image of the at least one scene in which identified objects determined as represented in the inventory comprises presenting the identified objects determined as represented in the inventory as unobscured objects in the display output.

Example 5 may include elements of example 4 where the display output including an image of the at least one scene in which identified objects determined as not represented in the inventory comprises presenting the identified objects determined as not represented in the inventory as obscured objects in the display output.

Example 6 may include elements of example 4 where the at least one defined criterion may include at least one of: a dietary criterion, a religious criterion, or a user-defined selection criterion.

Example 7 may include elements of example 1 where the at least one display device may include at least one wearable display device.

Example 8 may include elements of any of examples 1 through 7 and may further include at least one communications interface communicably coupled to the at least one circuit, wherein the object inventory is maintained, at least in part, as a data store on a remote storage device and the remote storage device is accessed by the display controller circuit via the at least one communications interface.

Example 9 may include elements of any of examples 1 through 7 and may additionally include at least one geolocation transceiver communicably coupled to the at least one circuit, where the at least one machine-readable instruction set that cause the display controller circuit to identify objects included in a number of scenes captured by the at least one data acquisition device. The at least one display controller circuit may further access a data store that includes information indicative of objects and a geolocation logically associated with the respective geolocation; and identify objects included in the number of scenes captured by the at least one data acquisition device based, at least in part, on a geolocation logically associated with the identified object.

Example 10 may include elements of example 1 where the object inventory may be maintained, at least in part, as a data store in the at least one storage device.

According to example 11 there is provided a selective display method. The method may include capturing, by an image acquisition device, data representative of at least one scene including a plurality of objects. The method may further include identifying, by at least one display controller circuit communicably coupled to the image acquisition device, at least some of the plurality of objects included in the data representative of the at least one scene. The method may additionally include determining which of the identified objects included in the at least one scene are represented in an inventory that includes objects meeting at least one defined criterion. The method may further include generating, by the display controller circuit, an output on a communicably coupled display device, the output including an image of the at least one scene in which identified objects determined as represented in the inventory are presented in a first format and identified objects determined as not represented in the inventory are presented in a second format.

Example 12 may include elements of example 11 where capturing data representative of at least one scene including a plurality of objects may include capturing data representative of at least one scene including a plurality of objects in the visible electromagnetic spectrum of from about 390 nanometers (nm) to about 700 nm.

Example 13 may include elements of example 11 where identifying at least some of the plurality of objects may include identifying at least some of the plurality of objects using optical object detection and identification.

Example 14 may include elements of example 11 where identifying at least some of the plurality of objects may include identifying at least some of the plurality of objects using at least one coding scheme including at least one of: a bar code, a two-dimensional matrix code, or a three-dimensional matrix code.

Example 15 may include elements of example 11 where generating an output including an image of the at least one scene in which identified objects determined as represented in the inventory are presented in a first format may include generating an output that includes data representative of an image of the at least one scene in which identified objects determined as represented in the inventory are presented as unobscured objects.

Example 16 may include elements of example 15 where generating an output including an image of the at least one scene in which identified objects determined as not represented in the inventory are presented in a second format may include generating an output that includes data representative of an image of the at least one scene in which identified objects determined as not represented in the inventory are presented as obscured objects.

Example 17 may include elements of example 11 where determining which of the identified objects are represented in an inventory that includes objects meeting at least one defined criterion may include determining which of the identified objects are represented in the inventory, the inventory including objects meeting at least one defined criterion including one or more of the following: at least one defined dietary criterion, at least one defined religious criterion, at least one defined cultural criterion, at least one defined ethnic on or at least one defined geographic criterion.

Example 18 may include elements of any of examples 11 through 17 and may additionally include receiving, by the display controller circuit, at least one input indicative of the one or more defined criteria; and generating, by the display controller circuit, the inventory based at least in part on the at least one received input.

Example 19 may include elements of any of examples 11 through 17 and may additionally include receiving, by the display controller circuit, location data indicative of a geolocation of the scene, where identifying at least some of the plurality of objects included in the at least one scene may include identifying at least some of the plurality of objects included in the at least one scene based at least in part on the location data indicative of the geolocation of the scene.

Example 20 may include elements of example 19 where receiving location data indicative of a geolocation of the scene may include at least one of receiving absolute location data using at least one geolocation identification system (GPS, GLONASS) or receiving relative location data using a plurality of fixed terrestrial beacons.

According to example 21, there is provided a storage device that includes machine-readable instruction sets that, when executed by a processor, cause the processor to function as a specialized display controller circuit. The display controller circuit may cause an image acquisition device to capture data representative of at least one scene including a plurality of objects. The display controller circuit may further identify at least some of the plurality of objects included in the data representative of the at least one scene. The display controller circuit may further determine which of the identified objects included in the at least one scene are represented in an inventory that includes objects meeting one or more defined criteria and generate a display output including an image of the at least one scene in which identified objects determined as represented in the inventory are presented in a first format and identified objects determined as not represented in the inventory are presented in a second format.

Example 22 may include elements of example 21 where the machine-readable instruction sets may further cause the display controller circuit to cause the image acquisition device to capture data representative of at least one scene in the visible electromagnetic spectrum of from about 390 nanometers (nm) to about 700 nm.

Example 23 may include elements of example 21 where the machine-readable instruction sets may further cause the display controller circuit to cause the image acquisition device to capture data representative of at least one scene in the visible electromagnetic spectrum and at least a portion of at least one non-visible portion of the electromagnetic spectrum of less than about 390 nanometers (nm) or greater than about 700 nm.

Example 24 may include elements of example 21 where the machine-readable instruction sets that cause the display controller circuit to identify at least some of the plurality of objects may further cause the display controller circuit to identify at least some of the plurality of objects using optical object detection and identification.

Example 25 may include elements of example 21 where the machine-readable instruction sets that cause the display controller circuit to identify at least some of the plurality of objects may further cause the display controller circuit to identify at least some of the plurality of objects using at least one coding scheme including at least one of: a bar code, a two-dimensional matrix code, or a three-dimensional matrix code.

Example 26 may include elements of example 21 where the machine-readable instruction sets that cause the display controller circuit to generate an output in which identified objects determined as represented in the inventory are presented in a first format may further cause the display controller circuit to generate an output including an image of the at least one scene in which identified objects determined as represented in the inventory are presented as unobscured objects.

Example 27 may include elements of example 26 where the machine-readable instruction sets that cause the display controller circuit to generate an output in which identified objects determined as not represented in the inventory are presented in a second format may further cause the display controller circuit to generate an output including an image of the at least one scene in which identified objects determined as not represented in the inventory are presented as obscured objects.

Example 28 may include elements of example 21 where the machine-readable instruction sets that cause the display controller circuit to determine which of the identified objects are represented in an inventory that includes objects meeting at least one defined criterion may further cause the display controller circuit to determine which of the identified objects are represented in an inventory that includes objects meeting at least one defined criterion including one or more of the following: at least one defined dietary criterion, at least one defined religious criterion, at least one defined cultural criterion, at least one defined ethnic criterion, or at least one defined geographic criterion.

Example 29 may include elements of any of examples 21 through 28 where the machine-readable instruction sets, when executed, may further cause the display controller circuit to receive at least one input indicative of the at least one defined criterion and generate the inventory based at least in part on the at least one received input.

Example 30 may include elements of any of examples 21 through 28 where the machine-readable instruction sets, when executed, may further cause the display controller circuit to receive location data indicative of a geolocation of the scene where the machine-readable instruction sets that cause the display controller circuit to identify at least some of the plurality of objects, may further cause the display controller circuit to identify at least some of the plurality of objects based at least in part on the location data indicative of the geolocation of the scene.

Example 31 may include elements of example 30 where the machine-readable instruction sets that cause the display controller circuit to receive location data indicative of a geolocation of the scene may further cause the display controller circuit to receive absolute location data using at least one geolocation identification system (GPS, GLONASS) or receive relative location data using a plurality of fixed terrestrial beacons.

According to example 32, there is provided a display system for the selective display of objects. The display system may include a means for capturing data representative of at least one scene including a plurality of objects. The system may further include a means for identifying at least some of the plurality of objects included in the data representative of the at least one scene. The display system may also include a means for determining which of the identified objects included in the at least one scene are represented in an inventory that includes objects meeting at least one defined criterion and a means for generating an output including an image of the at least one scene in which identified objects determined as represented in the inventory are presented in a first format and identified objects determined as not represented in the inventory are presented in a second format.

Example 33 may include elements of example 32 where the means for capturing data representative of at least one scene including a plurality of objects may include a means for capturing data representative of at least one scene including a plurality of objects in the visible electromagnetic spectrum of from about 390 nanometers (nm) to about 700 nm.

Example 34 may include elements of example 32 where the means identifying at least some of the plurality of objects included in the at least one scene may include an optical object detection and identification means for identifying at least some of the plurality of objects included in the at least one scene.

Example 35 may include elements of example 32 where the means for identifying at least some of the plurality of objects included in the at least one scene may include an encoding means for identifying at least some of the plurality of objects included in the at least one scene.

Example 36 may include elements of example 32 where the means for generating a display output including an image of the at least one scene in which identified objects determined as represented in the inventory are presented in a first format may include a means for generating a display output that includes an image of the at least one scene in which identified objects determined as represented in the inventory are presented as unobscured objects.

Example 37 may include elements of example 36 where the means for generating a display output including an image of the at least one scene in which identified objects determined as not represented in the inventory are presented in a second format may include a means for generating a display output that includes an image of the at least one scene in which identified objects determined as not represented in the inventory are presented as obscured objects.

Example 38 may include elements of example 32 where the means for determining which of the identified objects are represented in an inventory that includes objects meeting one or more defined criteria may include a means for determining which of the identified objects included in the at least one scene are represented in an inventory that includes objects meeting one or more defined criteria that include at least one of the following: at least one defined dietary criterion, at least one defined religious criterion, at least one defined cultural criterion, at least one defined ethnic criterion, or at least one defined geographic criterion.

Example 39 may include elements of any of examples 32 through 38 and may additionally include a means for receiving at least one input indicative of the one or more defined criteria and a means for generating the inventory based at least in part on the at least one received input.

Example 40 may include elements of any of examples 32 through 38 and may additionally include a means for receiving, by the display controller circuit, location data indicative of a geolocation of the scene, where the means for identifying at least some of the plurality of objects may include a means for identifying at least some of the plurality of objects based at least in part on the location data indicative of the geolocation of the scene.

Example 41 may include elements of example 40 where the means for receiving location data indicative of a geolocation of the scene may include at least one of a means for receiving absolute location data using at least one geolocation identification system (GPS, GLONASS) or a means for receiving relative location data using a plurality of fixed terrestrial beacons.

According to example 42, there is provided a system for selective display of objects, the system being arranged to perform the method of any of examples 11 through 20.

According to example 43, there is provided a chipset arranged to perform the method of any of examples 11 through 20.

According to example 44, there is provided at least one machine-readable medium comprising a plurality of instructions that, in response to be being executed on a computing device, cause the computing device to carry out the method according to any of examples 11 through 20.

According to example 45, there is provided a device configured for selective display of objects, the device being arranged to perform the method of any of examples 11 through 20.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A display system to selectively display objects meeting at least one criterion, the display system comprising:
at least one image data acquisition device;
at least one output device; and
at least one display controller circuit communicably coupled to the at least one image data acquisition device and to the at least one output device, the at least one display controller circuit to:
captures data representative of at least one scene including a plurality of objects;
identifies at least some of the plurality of objects included in the data representative of the at least one scene;
determines which of the identified objects included in the at least one scene are represented in an inventory that includes objects meeting at least one defined criterion; and
generates a display output in which identified objects determined as represented in the inventory are presented in a first format and identified objects determined as not represented in the inventory are presented in a second format.

2. The display system of claim 1 wherein the at least one image data acquisition device comprises at least one optical data acquisition device capable of collecting image data in the visible spectrum of from about 390 nanometers (nm) to about 700 nm.

3. The display system of claim 1 wherein:
the display output in which identified objects determined as represented in the inventory includes presenting the identified objects determined as represented in the inventory as unobscured objects; and
the display output in which identified objects determined as not represented in the inventory includes presenting the identified objects determined as not represented in the inventory as obscured objects.

4. The selective display system of claim 3 wherein the at least one defined criterion includes: at least one defined dietary criterion, at least one defined religious criterion, at least one defined cultural criterion, at least one defined ethnic criterion or at least one defined geographic criterion.

5. The selective display system of claim 1 wherein the at least one display device includes at least one wearable display device.

6. The display system of claim 5 wherein:
the at least one output device comprises at least one head-mounted augmented reality glass lens;
the display output in which identified objects determined as represented in the inventory includes an output on at least one head-mounted augmented reality glass lens in which a clear line-of-sight exists to the identified objects; and
the display output in which identified objects determined as not represented in the inventory includes an output on the at least one head-mounted augmented reality glass lens in which an obstructed line-of-sight exists to the identified objects determined as not represented in the inventory.

7. The display system of claim 6 wherein the display output on the at least one head-mounted augmented reality glass lens includes a clear line-of-sight and one or more unidentified object designators for each unidentified object included in the at least one image of the scene.

8. The selective display system of any of claims 1 through 7, further comprising:
at least one communications interface communicably coupled to the at least one display controller circuit, wherein the object inventory is maintained, at least in part, as a data store on a remote storage device communicably coupled to the at least one display controller circuit via the at least one communications interface.

9. The selective display system of any of claims 1 through 7, further comprising:
at least one geolocation transceiver communicably coupled to the at least one display controller circuit;
the at least one display controller circuit to further:
access a data store that includes information indicative of objects and a geolocation logically associated with the respective geolocation; and
identify objects included in the number of scenes captured by the at least one data acquisition device based, at least in part, on a geolocation logically associated with the identified object.

10. A display method, comprising:
capturing, by an image acquisition device, data representative of at least one scene including a plurality of objects;
identifying, by at least one display controller circuit communicably coupled to the image acquisition device, at least some of the plurality of objects included in the data representative of the at least one scene;
determining which of the identified objects included in the at least one scene are represented in an inventory that includes objects meeting at least one defined criterion; and
generating, by the at least one display controller circuit, an output on a communicably coupled display device, in which the identified objects determined as represented in the inventory are presented in a first format and the identified objects determined as not represented in the inventory are presented in a second format.

11. The display method of claim 10 wherein capturing data representative of at least one scene including a plurality of objects comprises capturing data representative of at least one scene including a plurality of objects in the visible electromagnetic spectrum of from about 390 nanometers (nm) to about 700 nm.

12. The display method of claim 10 wherein identifying at least some of the plurality of objects includes:
identifying at least some of the plurality of objects using optical object detection and identification.

13. The display method of claim 10 wherein identifying at least some of the plurality of objects includes:
identifying at least some of the plurality of objects using at least one coding scheme including at least one of: a bar code, a two-dimensional matrix code, or a three-dimensional matrix code.

14. The display method of claim 10 wherein:
generating an output including in which the identified objects determined as represented in the inventory are presented in a first format includes generating an output that includes an image of the at least one scene in which the identified objects determined as represented in the inventory are presented as unobscured objects; and
generating an output in which the identified objects determined as not represented in the inventory are presented in a second format includes generating an output that includes an image of the at least one scene in which the identified objects determined as not represented in the inventory are presented as obscured objects.

15. The display method of claim 10 wherein:
generating an output including in which the identified objects determined as represented in the inventory are presented in a first format includes generating an output on at least one head-mounted augmented reality glass lens in which a clear line-of-sight exists to the identified objects determined as represented in the inventory; and
generating an output in which the identified objects determined as not represented in the inventory are presented in a second format includes generating an output on the at least one head-mounted augmented reality glass lens in which an obstructed line-of-sight exists to the identified objects determined as not represented in the inventory.

16. The display method of claim 10 wherein determining which of the identified objects are represented in an inventory that includes objects meeting at least one defined criterion comprises:
determining which of the identified objects are represented in the inventory, the inventory including objects meeting at least one defined criterion including one or more of the following: at least one defined dietary criterion, at least one defined religious criterion, at least one defined cultural criterion, at least one defined ethnic criterion or at least one defined geographic criterion.

17. The display method of any of claims 10 through 16, further comprising:
receiving, by the at least one display controller circuit, at least one input indicative of the one or more defined criteria; and
generating, by the at least one display controller circuit, the inventory based at least in part on the at least one received input.

18. The display method of any of claims 10 through 16, further comprising:
receiving, by the at least one display controller circuit, location data indicative of a geolocation of the scene;
wherein identifying at least some of the plurality of objects included in the at least one scene comprises identifying at least some of the plurality of objects included in the at least one scene based at least in part on the location data indicative of the geolocation of the scene.

19. A storage device that includes machine-readable instruction sets that, when executed by at least one circuit, cause the at least one circuit to function as at least one specialized at least one display controller circuit that:
causes an image acquisition device to capture data representative of at least one scene including a plurality of objects;
identifies at least some of the plurality of objects included in the data representative of the at least one scene;
determines which of the identified objects included in the at least one scene are represented in an inventory that includes objects meeting one or more defined criteria; and
generates a display output in which identified objects determined as represented in the inventory are presented in a first format and identified objects determined as not represented in the inventory are presented in a second format.

20. The storage device of claim 19 wherein the machine-readable instruction sets further cause the at least one display controller circuit to:
cause the image acquisition device to capture data representative of at least one scene in the visible electromagnetic spectrum of from about 390 nanometers (nm) to about 700 nm.

21. The storage device of claim 19 wherein the machine-readable instruction sets further cause the at least one display controller circuit to:
cause the image acquisition device to capture data representative of at least one scene in the visible electromagnetic spectrum and at least a portion of at least one non-visible portion of the electromagnetic spectrum of less than about 390 nanometers (nm) or greater than about 700 nm.

22. The storage device of claim 19 wherein the machine-readable instruction sets that cause the display controller circuit to identify at least some of the plurality of objects further cause the at least one display controller circuit to:
identify at least some of the plurality of objects using optical object detection and identification.

23. The storage device of claim 19 wherein the machine-readable instruction sets that cause the at least one display controller circuit to identify at least some of the plurality of objects further cause the at least one display controller circuit to:
identify at least some of the plurality of objects using at least one coding scheme including at least one of: a bar code, a two-dimensional matrix code, or a three-dimensional matrix code.

24. The storage device of claim 19 wherein:
the machine-readable instruction sets that cause the at least one display controller circuit to generate an output in which the identified objects determined as represented in the inventory are presented in a first format causes the at least one display controller circuit to generate an output in which the identified objects determined as represented in the inventory are presented as unobscured objects; and
the machine-readable instruction sets that cause the at least one display controller circuit to generate an output in which the identified objects determined as not represented in the inventory are presented in a second format causes the at least one display controller circuit to generate an output in which the identified objects determined as not represented in the inventory are presented as obscured objects.

25. The storage device of claim 19 wherein:
the machine-readable instruction sets that cause the at least one display controller circuit to generate an output in which the identified objects determined as represented in the inventory are presented in a first format causes the at least one display controller circuit to generate an output on an augmented reality device in which an unobscured line-of sight exists to each of the identified objects determined as represented in the inventory; and
the machine-readable instruction sets that cause the at least one display controller circuit to generate an output in which the identified objects determined as not represented in the inventory are presented in a second format causes the at least one display controller circuit to generate an output on the augmented reality device in which an obscured line-of sight exists to each of the identified objects determined as not represented in the inventory.
